(19) United States
(12) Patent Application Publication
(10) Pub. No.: US 2010/0029383 A1
(43) Pub. Date: Feb. 4, 2010

(54) REMOTE CONTROL AND TELEVISION AND METHOD FOR PLAYING A GAME

(75) Inventor: LUNG DAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/511,045

(22) Filed: Jul. 28, 2009

(30) Foreign Application Priority Data
Jul. 31, 2008 (CN) 200810303264.9

(51) Int. Cl. A63F 13/00; A63F 9/24

(52) U.S. Cl. 463/31; 463/36; 463/43

(57) ABSTRACT

A remote control includes an input means, a transmitter, an interface unit, and a control unit. The input means is arranged with a mode selection key, the mode selection key is capable of being actuated to change the remote control between a TV mode for adjusting various setting of the television and an update mode for transmitting an execution game program to the television. The interface unit is capable of being coupled to an external device that stores an updated game program, the updated game program includes an execution program and a key setting program. The control unit extracts the execution program and the key setting program from the game program by actuating the mode selection key to switch the remote control to the update mode, setting corresponding game control function of the input means by processing the key setting program, and controlling the transmitter to transmit the execution program to the television.

### BACKGROUND

1. Technical Field

The disclosed embodiments relate to televisions, and more particularly to a method for playing games using a television and a remote control.

2. Description of Related Art

Nowadays, most television (TV) sets are not only used for receiving and displaying TV programs, but also may be used for implementing other functions, such as playing games.

However, most games are embedded in the television sets by manufacturers. Games may not be easily updated and stored in the television sets after the television sets are manufactured, thus users may not be able to play the updated games via the television sets.

What is needed, therefore, is a remote control, a television, and a method for overcoming the above described limitation.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a television in association with a remote control in accordance with an exemplary embodiment.

FIG. 2 is a top view of the remote control of FIG. 1 in accordance with an exemplary embodiment.

FIG. 3 is a block diagram of the television and the remote control of FIG. 1 in accordance with an exemplary embodiment.

FIG. 4 is a flowchart illustrating a method for playing an updated game via the television.

### DETAILED DESCRIPTION

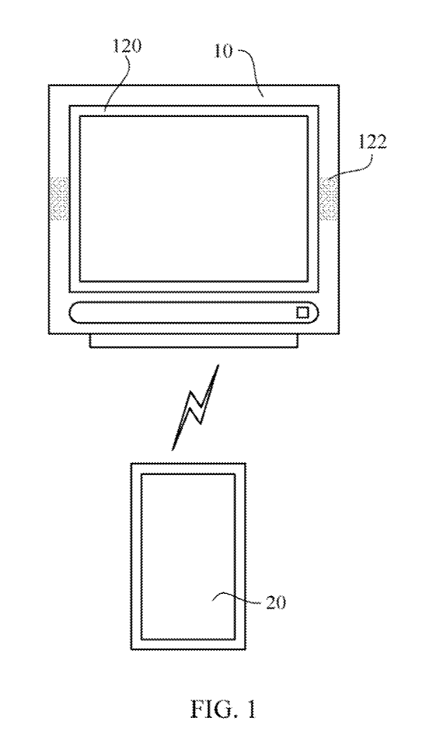

Referring to FIG. 1, a schematic view of a television 10 in association with a remote control 20 is illustrated. The television 10 may be a typical digital television configured to receive digital television signals transmitted according to industry standards including such as the advanced television systems committee (ATSC) standard, the digital video broadcasting-terrestrial (DVB-T) standard, and/or the integrated services digital broadcasting-terrestrial (ISDB-T) standard. The television 10 basically includes a display screen 120 and a speaker 122 for outputting video and audio information respectively.

The remote control 20 may be operated to switch between a TV mode, an update mode, and a game mode. In the TV mode, the remote control 20 controls the television 10 to adjust various settings, such as television channel and/or volume. In the update mode, the remote control 20 transmits an updated game to the television 10, the updated game may be a new features or a newer version of a previous game that does not exist in the television 10. In the game mode, the remote control 20 interacts with video games of the television 10. The video games may be pre-stored games embedded in the television 10 by manufacturers. The video games also may be the updated game uploaded from the remote control 20.

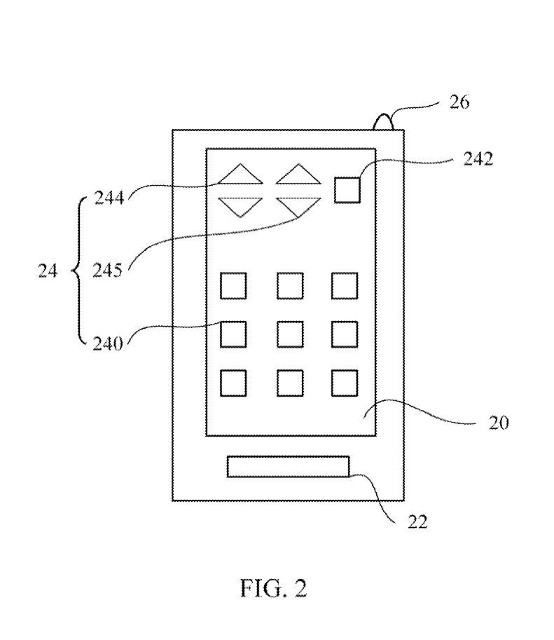

Referring to FIG. 2, a top view of the remote control 20 is illustrated. The remote control 20 includes an interface unit 22, a keypad 24, and a transmitter 26. The interface unit 22 is particularly designed to allow the updated game to be downloaded from external devices. The remote control 20 is more portable than the television 10, thus, it is more convenient to download the updated game via the remote control 20. In one implementation, the interface unit 22 includes a SanDisk (SD) card slot. The SD card slot is capable of receiving a SD card that stores the updated game program.

The updated game program includes an execution program and a key setting program. The key setting program includes software instructions implemented by a processor to set game control functions of the keypad 24, so that the keypad 24 is usable for the updated game. The execution program includes software instructions invoked by a processor to generate video game data and audio game data, the video game data is processed by a video processor of the television 10 to generate video game information, and the audio game data is processed by an audio processor of the television 10 to generate audio game information. The video game information represents a video portion of the updated game, the audio game information represents an audio portion of the updated game.

The updated game program stored on the SD card may be purchased from a retailer or downloaded from a server. In other implementation, the interface unit 22 may include a universal serial bus (USB) interface, and/or an optical disc drive interface. Correspondingly, the external device may be a SD card, and/or an optical disc.

The keypad 24 includes a plurality of keys 240, a mode selection key 242, a channel key 244, and a volume key 245. The plurality of keys 240 are appropriately arranged like a typical telephone keypad. Each of the plurality of keys 240 is associated with a number or multiple characters/letters. The mode selection key 242 is operable to change the mode of the remote control 20 between the TV mode, the update mode, and the game mode. In this embodiment, the remote control 20 is changed to one of the TV mode and the game mode by depressing the mode selection key 242 one time. The remote control 20 is changed to the update mode by depressing the mode selection key 242 two times.

When the mode selection key 242 is actuated to change the television 10 to the TV mode, the channel keys 244 are configured for selecting channels of the television 10. It should be noted that the channels can also be selected by the plurality of keys 240. The volume keys 245 are configured for adjusting the volume of the television 10.

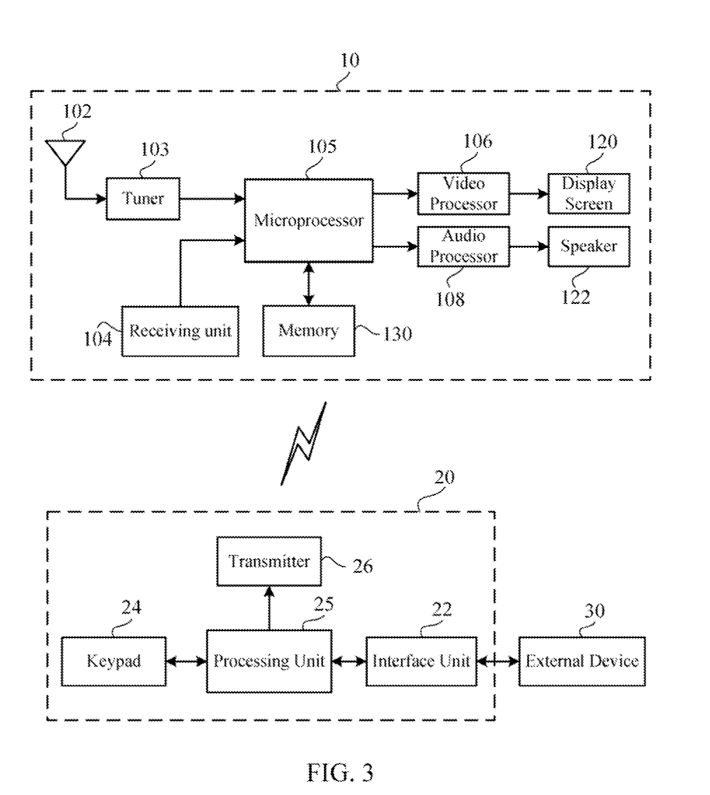

Referring also to FIG. 3, the remote control 20 further includes a processing unit 25 and a storage unit 28. The interface unit 22 is coupled to an external device 30 that stores the updated game program. When the mode selection key 242 is actuated to switch the remote unit 20 to the update mode, the processing unit 25 is configured for downloading/receiving the updated game program from the external device 30 via the interface unit 22.

The processing unit 25 is also used for extracting the key setting program and the execution program from the updated game program. The processing unit 25 sets the game control function of the keypad 24 by processing the key setting program, so that the keypad 24 is usable for the updated game. For example, if the updated game program relates to a racing game, the channel keys 244 may be configured to function as game start/pause keys, the volume keys 245 may be configured to function as speed up/down keys, the plurality of keys 240 may be configured to function as game role selection keys or game role control keys. The processing unit 25 further controls the transmitter 26 to wirelessly transmit the execution program to the television 10. The transmitter 26 can be an infrared transmitting device or a Bluetooth® device.

The television 10 generally includes a receiving unit 104, a microprocessor 105, a video processor 106, an audio processor 108, a display screen 120, a speaker 122, and a memory 130. The receiving unit 104 is used for receiving the execution program transmitted by the remote control 20. The microprocessor 105 is connected to the receiving unit 104, downloads/receives the execution program from the receiving unit 104, and stores the execution program in the memory 130.

When the mode selection key 242 is actuated to switch the remote unit 20 to the game mode, the receiving unit 104 is used for receiving a command from the remote control 20. The microprocessor 105 invokes the execution program stored in the memory 130 according to the command, so as to generate the video game data and the audio game data. The receiving unit 104 may be an infrared receiving device or a Bluetooth® device. The microprocessor 105 may also implement the pre-stored game program which is embedded in the television 10 by the manufacturers.

The video processor 106 processes the video game data to generate the video game information that represents the video portion of the updated game, and provides the video game information to the display screen 120, so as to reproduce display images. The audio processor 108 processes the audio game data to generate audio game information that represents the audio portion of the updated game, and provides the audio game information to the speaker 122, so as to generate audible sound. As a result, the television 10 can process the updated game.

The television 10 further includes an antenna 102, and a tuner 103. In TV mode, the antenna 102 is configured for receiving digital broadcasting signals. The digital broadcasting signals are transmitted in the form of electromagnetic carrier waves over the air at predetermined frequencies. The antenna 102 generates radio frequency (RF) signals based on the digital broadcasting signals.

The tuner 103 receives channel selection signals from the microprocessor 105 in response to input commands from the remote control 20. The tuner 103 further converts selected RF signals into intermediate frequency (IF) signals, and demodulates the IF signals to generate digital baseband signals. The digital baseband signals generally include video data, audio data, and extended service data such as closed caption data.

The microprocessor 105 receives the digital baseband signals from the tuner 103, and processes the digital baseband signals to generate encoded video data and encoded audio data. The encoded video data may be encoded and/or compressed according to video standards, such as MPEG-2, MPEG-4, etc. The encoded audio data may be encoded and/or compressed according to Dolby Digital® audio standard.

The video processor 106 decompresses and/or decodes the encoded video data from the microprocessor 105 and provides decoded video signals representative a video portion of a program channel. The video portion of the program channel is displayed by the display screen 120.

The audio processor 108 decompresses and/or decodes the encoded audio data from the microprocessor 105 and provides decoded audio signals representative an audio portion of a program channel. The audio portion of the program channel is output from the speaker 122.

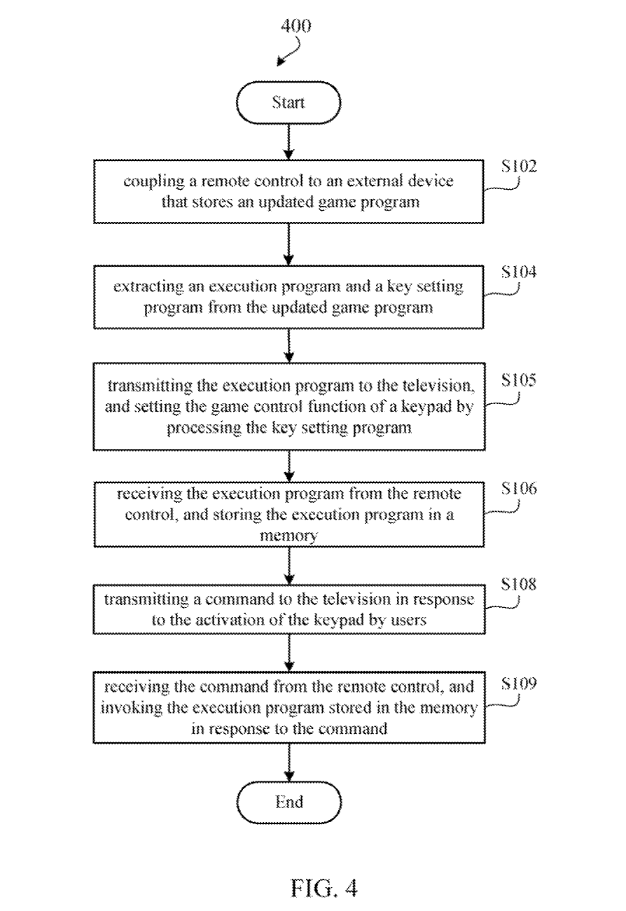

Referring to FIG. 4, a method 400 for playing the updated game via the television 10 is illustrated. The method includes following steps:

At step S102, the remote control 20 is coupled to an external device 30 that stores an updated game program. The updated game program includes an execution program and a key setting program. The key setting program includes software instructions implemented by a processor to set game control functions of the keypad 24, so that the keypad 24 is usable for the updated game. The execution program includes software instructions implemented by a processor to generate video game data and audio game data, the video game data is processed by the video processor 106 to generate video game information, and the audio game data is processed by the audio processor 108 to generate audio game information. The video game information represents a video portion of the updated game, the audio game information represents an audio portion of the updated game.

At step S104, the remote control 20 extracts the execution program and the key setting program from the updated game program when the mode selection key 242 is actuated to switch the remote control 20 to the update mode.

At step S105, the remote control 20 transmits the execution program to the television 10, and sets the game control function of the keypad 24 by processing the key setting program, so that the keypad 24 is usable for the updated game.

At step S106, the television 10 receives the execution program from the remote control 20, and stores the execution program in the memory 130.

At step S108, the remote control 20 transmits a command to the television 10 in response to activation of the keypad 24 by users when the mode selection key 242 is actuated to switch the remote control 20 to the game mode.

At step S109, the television 10 receives the command from the remote control 20, and invokes the execution program stored in the memory 130 in response to the command. In another embodiment, the television 10 may automatically invoke the execution program when the execution program is received completely.

Alternative embodiments will become apparent to those skilled in the art to which the present invention pertains without departing from the spirit and scope. Accordingly, the present invention should be deemed not to be limited to the above detailed description, but rather by the claims that follow.

What is claimed is:

1. A remote control for remotely controlling a television, the remote control comprising:
an input means arranged with a mode selection key, the mode selection key capable of being actuated to change the remote control between a TV mode for adjusting various setting of the television and an update mode for transmitting an execution game program to the television;
a transmitter;
an interface unit capable of being coupled to an external device that stores an updated game program, the updated game program comprising the execution program and a key setting program; and
a processing unit for extracting the execution program and the key setting program from the updated game program by actuating the mode selection key to switch the remote control to the update mode, setting corresponding game control function of the input means by processing the key setting program, and controlling the transmitter to transmit the execution program to the television.

2. The remote control according to claim 1, wherein the mode selection key is also capable of being actuated to change the remote control to a game mode for interacting with video games of the television, the video games may be pre-stored games embedded in the television by manufacturers, the video games also may be the updated game uploaded from the remote control.

3. The remote control according to claim 2, wherein the remote control is changed to one of the TV mode and the game mode by depressing the mode selection key one time, the remote control is changed to the update mode by depressing the mode selection key two times.

4. The remote control according to claim 1, wherein the transmitter may be one of a Bluetooth® device and an infrared transmitting device.

5. The remote control according to claim 1, wherein the interface unit may be one of a universal serial bus interface, an optical disc drive interface, and a SD card slot.

6. A television capable of being controlled by a remote control to select program channel for showing television program, the television comprising:
a receiving means for receiving an execution program transmitted from the remote control, the execution program being extracted from a game program stored in the remote control;
a memory; and
a microprocessor for downloading the execution program from the receiving means, and storing the execution program in the memory; wherein the execution program is invoked by the microprocessor in response to a command received by the receiving means from the remote control.

7. The television according to claim 6, further comprising:
a video processor for processing video game data generated by the microprocessor that invokes the execution program, and generating video game information that represents a video portion of the updated game; and
a display screen for displaying the video game information.

8. The television according to claim 6, further comprising:
an audio processor for processing audio game data generated by the microprocessor that invokes the execution program, and generating audio game information that represents an audio portion of the updated game; and
a speaker for outputting the audio game information.

9. The television according to claim 6, wherein the receiving means may be one of an infrared receiving device and a Bluetooth® device.

10. A method for playing a game, the method comprising:
coupling a remote control to an external device that stores an updated game program, the updated game program comprising an execution program and a key setting program;
extracting the execution program and the key setting program from the updated game program when the remote control is switched to an update mode, the remote control comprising a keypad;
setting the game control function of the keypad by processing the key setting program;
transmitting the execution program to the television; and
receiving the execution program from the remote control, and storing the execution program in a memory of the television.

11. The method according to claim 10, further comprising:
transmitting a command to the television in response to activation of the keypad when the remote control is switched to the game mode;
receiving the command from the remote control; and
invoking the execution program stored in the memory in response to the command.

12. The method according to claim 10, wherein the action of transmitting the execution program to the television can be implemented by one of an infrared transmitting device and a Bluetooth® device.
